(19) United States
(12) Patent Application Publication
(10) Pub. No.: US 2018/0075829 A1
(43) Pub. Date: Mar. 15, 2018

(54) ANALOG AND DIGITAL AUDIO INTERFACE METHOD

(71) Applicant: Jed James Eaton, Knoxville, TN (US)

(72) Inventor: Jed James Eaton, Knoxville, TN (US)

(73) Assignee: Lineshark Audio Inc., Knoxville, TN (US)

(21) Appl. No.: 15/265,032

(22) Filed: Sep. 14, 2016

(51) Int. Cl. G10H 1/00; H04H 60/04; G06F 3/16; G11B 20/10

(52) U.S. Cl. CPC G10H 1/0058; H04H 60/04; G06F 3/162; G10H 2240/285; G06F 3/165; G06F 3/167; G10H 2240/321; G11B 20/10527

(57) ABSTRACT

An audio interface and related use of such interface is provided. The audio interface and its general technique enable a device such as a smartphone, notebook, tablet, computer, or similar processor based device to be more effectively used in audio applications; such as recording, playback, and real time effects.

A new and useful process improvement to audio interfaces is described, giving the ability to dynamically condition both analog and digital audio signals as well as dynamically select the direction of audio signals between analog and digital interfaces using switches, knobs, and other control methods.

The interface method and concept highlight flexibility in order to serve the broadest collection of use cases, for example, any analog audio signal shall be used in conjunction with any digital device or interface for the purpose of at least one of the following activities: recording, playback, and real time effects. This is unlike other methods which have been designed for more specific purposes and are limited in the number of ways a digital device can be utilized due to one or more of the following characteristics: signal connection options, signal routing options, and signal conditioning options.

The interface method describes functional blocks of general signal processing arranged into one or more array(s) of routing switches and process controls; enabling a better overall experience in utilizing analog and digital devices in professional audio applications.

### CROSS REFERENCE TO RELATED APPLICATIONS

Audio Interface Device and Method—U.S. Pat. No. 7,961,895

Digital Interface for Analog Audio Mixers—U.S. Pat. No. 7,421,084

USB Audio Controller—U.S. Pat. No. 7,962,668

### STATEMENT OF FEDERALLY SPONSORED RESEARCH OR DEVELOPMENT

NOT APPLICABLE

### PARTIES TO A RESEARCH AGREEMENT

NOT APPLICABLE

### BACKGROUND OF THE INVENTION

### 1. Field of the Invention

This invention generally relates to interfaces used in professional audio. More specifically this invention relates to interfaces used in analog as well as digital signal processing. These kinds of interfaces are used in live audio, studio, and other environments where the recording, conditioning, interfacing, and routing of audio signals may be desirable.

### 2. Description of Related Art

Digital and analog audio interfaces for processor based devices such as smart phones, tablets, notebooks, and computers are designed in limited ways in serving professional audio applications. Many interface solutions are designed for specific purposes and do not integrate well into the broad array of use cases that are possible. Numerous applications exist for processor based devices in professional audio, yet there is no single interface solution or method which can flexibly serve many of these individual use cases, nor are there any solutions which have been designed to support many individual use cases.

Modern musically inclined persons participate in a wide variety of tasks and utilize numerous different tools offered by analog and processor based circuitry such as recording, mixing, equalization, effects loops, backing tracks, looping machines, drum machines, dynamic sound generation, and more. Many of these individual interface solutions already exist, yet they utilize specific methods which limit the solution to a single aforementioned use case.

A single interface solution and method which simultaneously serves a much broader set uses cases can be realized. This is accomplished using a methodology where each input signal is individually controllable and has a dedicated output, constituting what is commonly referred to as a channel.

Each channel has as the ability to perform analog signal conditioning, dynamic signal routing, analog to digital conversion, and digital to analog conversion. Each channel may be user configured such that the individual blocks of signal conditioning, signal routing, digital to analog conversion, and analog to digital conversion can be used individually or in conjunction with one another. An interface method such as this, using what is commonly termed as professional audio connectors, enables modern digital devices like smart phones, notebooks, tablets and computers to be more effectively integrated into a much broader set of use cases. This enhances the usability of digital devices as well as the experience of the associated art form. A general design methodology of such a solution is described.

### Advantages

Modern musicians, musical artists, and others typically fulfill multiple tasks such as recording, playback, and the use of real time effects. These tasks are desirable in a live performance setting as well as in a recording or musical compilation setting.

Digital devices such as smart phones, notebooks, tablets, and computers can enable and enhance tasks such as recording, playback, and the use of real time effects in both performance settings as well as in recording and compilation settings. Digital devices such as mart phones, notebooks, tablets, and computers are widely deployed and continue to become commoditized. The analog and digital interface method utilizes signal conditioning and route switching in conjunction with a digital interface in order to more effectively support recording, playback, as well as the use of real time effects. The analog and digital interface method is scalable and offers functional as well as economic advantages; enhancing the experience and usability of digital devices in the production of sound and in the associated art form(s).

For example, the described analog and digital interface method may be used in conjunction with application(s) on a digital device to more easily capture and share sounds. The analog and digital interface method may be used to in conjunction with other audio systems in order to provide playback in a live performance environment. The analog and digital interface method may be used in conjunction with a digital device in order to produce an inexpensive real time sound effect. The analog and digital interface method may be used in conjunction with a digital device for the purpose of single and multi-track recording.

An interface with a method that supports many use cases provides exceptional value by turning any capable processor based device into numerous commonly understood devices, tools, and solutions such as a recorder, a tracking machine, a mixer, an equalizer, a synthesizer, an effects loop device or “stomp box,” a backing track, a looping machine, a drum machine, a karaoke machine, a digital audio workstation and more.

### DRAWINGS

FIG. 1 is a flowchart describing the analog and digital interface method

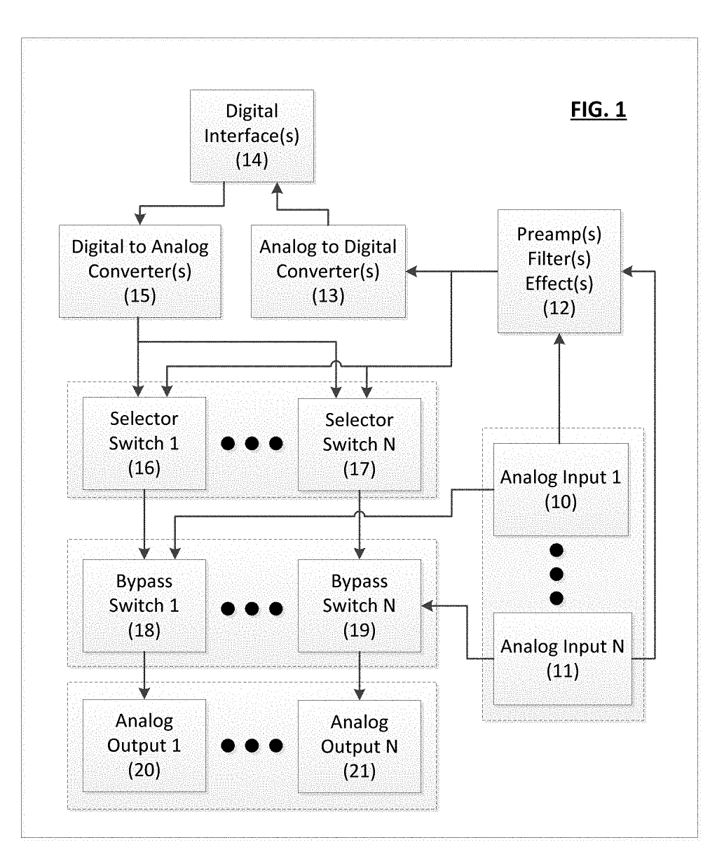

### DETAILED DESCRIPTION—FIG. 1

10 Primary analog input interface, such as an XLR or ¼″ or other balanced or unbalanced audio connector
11 Additional analog input interface(s), which may be the same or different from the primary interface
12 Operational amplifier or other active or passive electrical signal filter or electrical sub circuit, such as a preamplifier, delay circuit, equalizer circuit, distortion circuit, or other real time effect, or any low latency signal processing circuit or method
13 Analog to digital converter(s)
14 Digital interface(s), such as USB, Bluetooth, optical or other
15 Digital to analog converter(s), which may include one or more of the following: active electrical filters, passive electrical filters, and other general circuit(s) such as an operational amplifier or other signal conditioning method(s)
16 Primary output selector, such as a knob(s), switch(s), footswitch(s), button(s) or other control method for selecting between one, two, or more signal sources
17 Additional output selector(s), such as a knob(s), switch(s), footswitch(s), button(s) or other control method for selecting between one, two, or more signal sources
18 Primary output bypass switch(s) or general routing switch(s) such as a foot switch(s), generic switch(s), button(s), knob(s), or any other control method(s)
19 Additional output bypass switch(s) or routing switch(s), such as foot switch(s), generic switch(s), button(s), knob(s), or other control method(s)
20 Primary analog output interface, such as an XLR or ¼″ or other balanced or unbalanced audio connector
21 Secondary analog output interface(s), which may be the same or different from the primary interface

### CLAIMS

Certain embodiments of the present invention may include but are not limited to a musical foot pedal as known as a “stomp” pedal, a sound effects unit such as an equalizer or other, a signal routing unit such as a mixer or other, an analog or digital musical instrument such as a guitar or keyboard or other, a sound capture unit such as a single or multi track recorder or other, a volume box, a direct box as known as “DI” box or any other device used in the recording, synthesis, and altering of sounds.

I claim:

1. Any embodiment of a solution consisting of an enclosure(s) with features or functions which include but are not limited to:
a. One or more of the following: foot controllable switch(s) and general switch(s)
b. One or more of the following: USB, Bluetooth, digital interface(s), and digital interface connector(s)
c. One or more of the following analog audio input connector(s): 6.35 mm, XLR, balanced, and unbalanced
d. One or more of the following analog audio output connector(s): 6.35 mm, XLR, balanced, and unbalanced
e. A circuitry powered by at least one of the following: direct electrical current(s) and alternating electrical current(s)
f. One or more of the following: operational amplifier(s), active electrical signal filter(s), passive electrical signal filter(s) and other electrical signal filter method(s)
g. analog to digital as known as “A/D” converter(s)
h. digital to analog as known as “D/A” converter(s)
Where in:
a. each input signal may influence or may be influenced by one or more of the following: operational amplifier(s), active electrical signal filter(s), and passive electrical signal filter(s)
b. certain parameters of one or more operational amplifier(s) or signal filter(s) may be user configurable by knob, switch, or other control method
c. one or more A/D converter(s) sample one or more signal(s) which may include the original input signal(s) as well as the filtered or influenced input signal(s)
d. The active signal source of one or more output signal(s) is modulated, alternated, or otherwise selected using one or more switches, knobs, and other control methods.
e. the modulated source of one or more output signals may be user configurable by one or more knob(s), switch(s), or other control method(s) and consists of a selectable matrix or sub matrix of signals which can include but is not limited to:
1. the output of one or more of the following: operational amplifier(s), active electrical filters, and passive electrical filter(s)
2. the output of one or more D/A converter(s)
3. one or more input signal(s)
